(19) United States
(12) Patent Application Publication
(10) Pub. No.: US 2014/0265082 A1
(43) Pub. Date: Sep. 18, 2014

(54) Overhead Door Torsion Spring Adjuster

(71) Applicant: HALDEX BRAKE PRODUCTS CORPORATION, Kansas City, MO (US)

(72) Inventors: GLEN HEMAN, Levasy, MO (US); John Payne, Grain Valley, MO (US); David Payne, Oak Grove, MO (US)

(21) Appl. No.: 13/830,303

(22) Filed: Mar. 14, 2013

(51) Int. Cl. F16F 1/14

(52) U.S. Cl. CPC F16F 1/145
USPC 267/277

(57) ABSTRACT

An overhead door torsion spring adjuster having a housing, first and second gears positioned within the housing, and a first shaft coupled with the first gear. The second gear has a base positioned within the housing, a collar that is integral with the base, and an opening that extends through the base and collar. The base engages the first gear. The collar is operable to be coupled with a second shaft that is received by the opening. Preferably, the spring adjuster includes a locking mechanism that is operable to prevent rotation of the first shaft.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention is directed to an overhead door torsion spring adjuster, and in particular, to a spring adjuster with a gear operable to be directly coupled with a counterbalance shaft of a torsion spring assembly.

2. Description of Related Art

Overhead doors, such as trailer doors and garage doors, typically have a mechanism that assists in raising and lowering the door in a controlled manner. One such mechanism is a torsion spring assembly that includes one or more torsion springs which store energy to assist in raising and lowering the door. When the overhead door is closed, the torsion springs are twisted to store a preloaded amount of energy within the springs. That energy is released as the door is opened to assist in raising the door. As the door lowers, the torsion springs twist and store energy to assist in lowering the door in a controlled manner.

Typically, the torsion springs may be adjustably twisted a desired amount so that an operator may preload them with an amount of energy that allows the system to operate as desired. One conventional mechanism for adjusting the amount of energy stored within a torsion spring includes a cone that is joined to one end of the torsion spring. The cone may be releasably coupled with a shaft that passes through the center of the spring. The cone includes openings for receiving bars that an operator may use to twist the cone and preload the spring when the cone is not coupled with the shaft. When the spring has been twisted a desired amount, the operator couples the cone with the shaft. While effective to twist and preload a torsion spring, this type of mechanism may be relatively difficult and dangerous to operate for someone that is not experienced with the installation and repair of overhead doors.

Another mechanism for adjusting the amount of energy stored within torsion springs includes a gear box mounted to a surface adjacent the springs (See e.g. US 2012/0125545). The gear box includes a worm coupled with a worm wheel. The worm wheel includes an opening that receives a sleeve. The sleeve includes splines that are received by grooves in the worm wheel to mate the sleeve and worm wheel. The sleeve mounts to a shaft, which is joined to one end of each torsion spring. The worm is coupled with another shaft that is operable to be rotated by an operator for rotating the worm, worm wheel and sleeve to adjustably twist the springs a desired amount. Although, this type of adjustment mechanism is relatively easy to operate, it is also relatively complex because it includes a sleeve with a splined outer surface and a worm wheel with a grooved inner surface.

### BRIEF SUMMARY OF THE INVENTION

An overhead door torsion spring adjuster in accordance with an embodiment of the present invention includes a housing, first and second gears positioned within the housing, and a first shaft that is coupled with the first gear. The second gear has a base that is positioned within the housing and a collar that is integral with the base and that extends from the base at least partially outside of the housing. The base engages the first gear so that the second gear rotates with rotation of the first shaft and first gear. The second gear has an opening that extends through the base and the collar, which is operable to receive a second shaft. The collar is operable to be coupled with the second shaft.

In a preferred embodiment, the first gear is a worm and the second gear is a worm wheel. The base and collar of the worm wheel are preferably integrally formed together from the same material. Preferably, the first shaft is an adjustment shaft with a first end that is coupled with the worm and a second end that is positioned outside of the housing. The second end has a tool engaging structure to facilitate rotation of the adjustment shaft.

The spring adjuster preferably includes a locking mechanism that is moveable between a locked position, in which it prevents rotation of the adjustment shaft, and an unlocked position, in which the adjustment shaft may be rotated. The locking mechanism preferably has a locking collar that is moveable between the locked and unlocked positions, and a spring that biases the locking collar to the locked position.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of an overhead door with a torsion spring counterbalance assembly having a torsion spring adjuster in accordance with the present invention;

FIG. 2 is a bottom plan view of a portion of the torsion spring counterbalance assembly shown in FIG. 1;

FIG. 3 is a perspective view of the torsion spring adjuster shown in FIG. 1;

FIG. 4 is an exploded view of the torsion spring adjuster shown in FIG. 1;

FIG. 5 is a cross-sectional view of the torsion spring adjuster shown in FIG. 1; and

FIG. 6 is a perspective view of an alternative embodiment of overhead door torsion spring adjuster.

### DETAILED DESCRIPTION OF PREFERRED EMBODIMENT

An overhead door torsion spring adjuster in accordance with the present invention is shown generally as 10 in FIGS. 1-3. The spring adjuster 10 is one portion of a torsion spring counterbalance assembly 12 (FIG. 1) that assists in raising and lowering overhead door 14. The spring adjuster 10 may be used with any type of overhead door 14, including overhead doors on trailers and on buildings such as garages. The torsion spring counterbalance assembly 12 includes a counterbalance shaft 16 that is mounted to a surface 18 above door 14 with brackets 20 and 22. The counterbalance shaft 16 is coupled with spring adjuster 10 and a pair of torsion spring assemblies 24 and 26 as described below. Spring adjuster 10 may also be mounted to surface 18.

Because the torsion spring assemblies 24 and 26 are substantially identical, only torsion spring assembly 24 is described in detail herein with reference to FIG. 2. Torsion spring assembly 24 includes a torsion spring 28 that is wrapped around shaft 16. The ends of torsion spring 28 are coupled with cones 30 and 32 such that rotation of one of cones 30 and 32 twists spring 28. Cone 30 is joined with a pulley 34 around which is wound a cable 36. One end of cable 36 is joined to pulley 34 and the other end is joined to the bottom of overhead door 14 shown in FIG. 1. Cone 30 and pulley 34 rotate freely around shaft 16. Cone 32 is coupled with shaft 16 via a screw 38 that engages shaft 16 such that cone 32 and one end of spring 28 rotates with rotation of shaft 16.

As described in more detail below, the spring adjuster 10 is coupled to the shaft 16 and is operable to rotate the shaft 16, which rotates spring 28 and the spring of torsion spring assembly 26 and preloads the springs with a desired amount of energy. As the door 14 moves upward from its closed to its open position, spring 28 unwinds in a direction that unloads the preloaded energy stored therein. The unwinding of spring 28 causes rotation of cone 30 and pulley 34. Cable 36 winds around pulley 34 which creates tension in cable 36 that assists in raising door 14. As the door 14 moves downward from its open to its closed position, cable 36 unwinds from pulley 34 which causes rotation of pulley 34, cone 30 and spring 28. Spring 28 rotates in a direction that winds the spring 28 to store energy therein. Torsion spring assembly 26 operates simultaneously with torsion spring assembly 24 in a similar manner as described herein with respect to torsion spring assembly 24.

Referring to FIG. 4, torsion spring adjuster 10 includes a housing 40, a worm drive 42 positioned within the housing 40, an adjustment shaft 44 coupled with the worm drive 42, and a locking mechanism 46 which is operable to prevent unwanted movement of the adjustment shaft 44.

The housing 40 includes a base 48 and first and second covers 50 and 52 joined to opposite sides of the base 48 with rivets 54a-c that pass through openings 55a-c in base 48. The base 48 has an outer surface with first and second sides 56 and 58 to which the first and second covers 50 and 52 are joined, respectively, ends 60 and 62, top 64 and bottom 66. End 62 includes a pair of openings 67a and 67b, which may be threaded for receiving fasteners (not shown) to mount the spring adjuster 10 to surface 18 (FIG. 1). A cylindrical cavity 68 and adjacent rectangular cavity 70 are formed in the interior of the base 48. The cavities 68 and 70 are accessible through openings 72 and 74 in first and second sides 56 and 58, respectively. A shaft opening 76 in the bottom 66 extends from the outer surface of the base 48 to the rectangular cavity 70. A circular recess 78 is formed in the base 48 on the opposite side of cavity 70 from shaft opening 76. A recess 80 is formed in a protrusion 82 that extends outward from the outer surface of bottom 66. A grease port 84 extends from the outer surface of bottom 66 into the cylindrical cavity 68. A grease plug 86 screws into threads (not shown) surrounding grease port 84. It is within the scope of the invention for the grease plug 86 to be substituted for a grease fitting, such as a Zerk fitting, that allows an operator to lubricate the interior of the housing 40 without removing plug 86. Because each of the first and second covers 50 and 52 is substantially similar, only cover 50 is described in detail herein. Cover 50 is a generally planar sheet with a circular protrusion 88 that surrounds an opening 90 through the cover. The opening 90 is aligned with the openings 72 and 74 in base 48. An opening 92 in cover 52 is also aligned with the openings 72 and 74 in base 48.

Worm drive 42 includes intermeshed worm 94 and worm wheel 96. As shown in FIG. 5, worm 94 is positioned within the rectangular cavity 70, and worm wheel 96 is positioned partially within the cylindrical cavity 68. As shown in FIG. 4, worm 94 is generally cylindrical and has an outer surface with gear teeth 98 formed therein. An opening 100 passes longitudinally through the center of worm 94.

Worm wheel 96 has a base 102 positioned within cylindrical cavity 68 (FIG. 5) and a collar 104 that extends from base 102 through the opening 72 in housing 40 and opening 90 in cover 50 as shown in FIG. 3. Referring to FIG. 4, base 102 and collar 104 of worm wheel 96 are integrally formed together from the same material so that they form one piece. Base 102 is a cylinder with an outer surface 106 and an inner surface 108 (FIG. 5). Gear teeth 110 formed in outer surface 106 engage gear teeth 98 of worm 94 so that rotation of worm 94 causes rotation of worm wheel 96. Collar 104 is a cylinder with an outer surface 112 and an inner surface 114. The inner surface 108 of base 102 has the same diameter as the inner surface 114 of collar 104 such that there is a smooth transition between the surfaces 108 and 114. The inner surfaces 108 and 114 surround an opening 116 passing through the center of the worm wheel 96. Opening 116 is aligned with the openings 72 and 74 in base 48 and the openings 90 and 92 in covers 50 and 52, respectively. Opening 116 receives the counterbalance shaft 16 (FIG. 2), which passes through the openings 72 and 74 in base 48 and the openings 90 and 92 in covers 50 and 52, respectively. Outer surface 106 of base 102 has a larger diameter than outer surface 112 of collar 104.

Collar 104 has a pair of aligned holes 118 and 120 positioned on opposite sides of opening 116 each of which passes through the outer and inner surfaces 112 and 114 of collar 104. The holes 118 and 120 align with a hole (not shown) in counterbalance shaft 16. A pin 122 (FIG. 2) is inserted into the aligned holes 118 and 120 in collar 104 and the hole (not shown) in counterbalance shaft 16 to join the worm wheel 96 and counterbalance shaft 16.

Adjustment shaft 44 has a first end 124 that is pressed into opening 100 within worm 94 so that the adjustment shaft 44 and worm 94 rotate together. A second end 126 of adjustment shaft 44 is positioned outside of housing 40. The second end 126 includes a hexagonal bolt head 128 which is operable to be engaged by a tool for rotating the adjustment shaft 44 and worm 94. A cylindrical shaft 130 extends from bolt head 128 through shaft opening 76 in housing 40 to first end 124. Adjustment shaft 44 is positioned so that it is perpendicular to counterbalance shaft 16.

Locking mechanism 46 includes a locking collar 132 and spring 134. Locking collar 132 is positioned between spring 134 and bolt head 128 as shown in FIG. 5. Locking collar 132 is moveable between a locked position, in which it prevents rotation of adjustment shaft 44, and an unlocked position, in which adjustment shaft 44 may be rotated. FIG. 5 shows collar 132 in its locked position. Collar 132 moves downward and spring 134 compresses to move collar 132 to its unlocked position. Spring 134 biases locking collar 132 to its locked position. As shown in FIG. 4, locking collar 132 includes a cylindrical base 136 with a circular flange 138 extending outward from one end of the base 136. An opening 140 extends through the base 136 and flange 138. An inner surface 142 surrounding the opening has first, second, and third sections 142a-c (FIG. 5). First and second sections 142a-b are smooth, cylindrical side walls with first section 142a having a larger diameter than second section 142b so that a surface 144 is formed between and perpendicular to the sections 142a-b. The diameter of first section 142a is preferably slightly larger than the diameter of spring 134 so that a portion of spring 134 is received by opening 140 adjacent first section 142a. The diameter of second section 142b is preferably slightly larger than the diameter of adjustment shaft 44 so that a portion of adjustment shaft 44 is received by opening 140. Third section 142c is formed from a plurality of intersecting surfaces (shown in FIG. 4) that form a star shaped pattern, which is sized and configured so that it is operable to surround and abut bolt head 128 for preventing rotation of adjustment shaft 44 when the locking collar 132 is in its locked position. The cylindrical base 136 of locking collar 132 is positioned within recess 80. The third section 142c has a larger diameter than the second section 142b to form a surface 146 (FIG. 5) between and perpendicular to the sections 142b-c. Surface 146 abuts a bottom of bolt head 128 when the locking collar 132 is in its locked position in order to retain locking collar 132 within recess 80. Base 136 includes a protrusion 148 (FIG. 4) that is received by a groove 150 in housing 40 for preventing rotation of locking collar 132 so that it is able to prevent rotation of adjustment shaft 44 when in its locked position.

Spring 134 is positioned within recess 80. Spring 134 has an inner diameter that is slightly larger than the outer diameter of adjustment shaft 44 so that the adjustment shaft 44 passes through spring 134. Spring 134 has one end 134a that abuts a surface 152 of housing 40 surrounding opening 76, and another end 134b that abuts surface 144 of locking collar 132. The spring 134 is positioned so that it forces locking collar 132 toward bolt head 128. Spring 134 biases locking collar 132 to its locked position in which the third section 142c of inner surface 142 surrounds bolt head 128 and prevents rotation of bolt head 128. When locking collar 132 is in its unlocked position, spring 134 is compressed so that third section 142c does not surround bolt head 128. In this position, a tool may engage bolt head 128 for rotating adjustment shaft 44.

An alternative embodiment of spring adjuster in accordance with the present invention is identified generally as 200 in FIG. 6. Spring adjuster 200 may be substituted for spring adjuster 10 in the counterbalance assembly 12 shown in FIGS. 1 and 2. Spring adjuster 200 is substantially similar to spring adjuster 10. The only difference between the two is that spring adjuster 200 does not include the locking mechanism 46 of spring adjuster 10, and the housing 202 of spring adjuster 200 does not include the groove 150 of spring adjuster 10. Unwanted rotation of the adjustment shaft 204 of spring adjuster 200 is prevented by friction between the worm (not shown) and worm wheel 206 of the worm gear drive.

In operation, spring adjuster 10 is operable to adjustably preload torsion spring 28 (FIG. 2) with a desired amount of energy. In order to adjust torsion spring 28, an operator presses against the flange 138 of locking collar 132 with a socket to compress spring 134 until the socket surrounds bolt head 128. The socket is used to rotate the adjustment shaft 44 in a desired direction. Rotation of adjustment shaft 44 causes rotation of worm 94 and worm wheel 96, shown in FIG. 5, and also rotation of counterbalance shaft 16, cone 32, and torsion spring 28, shown in FIG. 2. Rotation of adjustment shaft 44 in one direction twists torsion spring 28 storing a greater amount of energy in the spring 28, and rotation in the opposite direction unwinds the spring to lessen the preloaded energy in the spring 28. The torsion spring of spring assembly 26 (FIG. 1) is adjusted simultaneously with, and in the same manner as, torsion spring 28. The spring adjuster 200 (FIG. 6) operates in the same manner except that the adjustment shaft 204 of spring adjuster 200 may be rotated without pressing against locking collar 132 to compress spring 134.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. An overhead door torsion spring adjuster, comprising:
a housing;
a first gear positioned within said housing;
a first shaft coupled with said first gear; and
a second gear comprising a base positioned within said housing and a collar that is integral with said base and extends from said base at least partially outside of said housing, wherein said base engages said first gear such that said second gear rotates with rotation of said first shaft and said first gear, wherein said second gear comprises an opening extending through said base and said collar, wherein said opening is operable to receive a second shaft, and wherein said collar is operable to be coupled with said second shaft.

2. The spring adjuster of claim 1, wherein said base and said collar are formed together from the same material.

3. The spring adjuster of claim 1, wherein said collar comprises a hole that aligns with a hole in said second shaft, and further comprising a pin operable to be received by said aligned holes in said collar and said second shaft.

4. The spring adjuster of claim 3, wherein said base comprises a cylinder with an outer surface having gear teeth formed therein and an inner surface surrounding a portion of said opening, wherein said collar comprises a cylinder with an outer surface and an inner surface having the same diameter as said inner surface of said base, and wherein said hole in said collar passes through said inner and outer surfaces of said collar.

5. The spring adjuster of claim 4, wherein said outer surface of said base has a larger diameter than said outer surface of said collar.

6. The spring adjuster of claim 1, further comprising a locking mechanism that is moveable between a locked position, in which it prevents rotation of said first shaft, and an unlocked position, in which said first shaft may be rotated.

7. The spring adjuster of claim 6, wherein said locking mechanism comprises a locking collar that is moveable between said locked and unlocked positions, and a spring that biases said locking collar to said locked position.

8. The spring adjuster of claim 7, wherein said housing comprises an opening that receives said first shaft and a recess surrounding said opening, wherein said first shaft comprises a first end that is coupled with said first gear and a second end, wherein said spring is positioned within said recess and said locking collar is positioned between said spring and said second end, and wherein said locking collar surrounds said second end when in its locked position.

9. The spring adjuster of claim 8, wherein said second end of said first shaft comprises a tool engaging structure.

10. The spring adjuster of claim 1, wherein said first gear comprises a worm and said second gear comprises a worm wheel.

11. The spring adjuster of claim 1, wherein said first shaft is generally perpendicular to said second shaft.

12. The spring adjuster of claim 1, wherein said first shaft is pressed into an opening within said first gear.

13. The spring adjuster of claim 1, wherein said housing comprises a base having first and second sides, and first and second covers joined to said first and second sides, respectively.

14. The spring adjuster of claim 13, wherein said housing comprises aligned first and second openings in said first cover and said first side, respectively, through which said collar extends, and wherein there is a third opening in said housing through which said first shaft extends.

15. An overhead door torsion spring adjuster, comprising:
a housing comprising an outer surface having first and second openings;
a worm drive comprising:
a worm positioned within said housing; and
a worm wheel comprising a base positioned within said housing and a collar that extends from said base through said first opening, wherein said base and said collar are integrally formed together from the same material, wherein said base comprises an outer surface having gear teeth formed therein that engage said worm such that said worm wheel rotates with rotation of said worm, wherein said worm wheel comprises a third opening extending through said base and said collar, wherein said third opening is operable to receive an overhead door shaft, and wherein said collar is operable to be coupled with said overhead door shaft outside of said housing; and
an adjustment shaft comprising a first end that is coupled with said worm and a second end positioned outside of said housing, wherein said adjustment shaft extends through said second opening, and wherein said second end comprises a tool engaging structure.

16. The spring adjuster of claim 15, wherein said collar comprises a hole that aligns with a hole in said overhead door shaft, and further comprising a pin operable to be received by said aligned holes in said collar and said overhead door shaft.

17. The spring adjuster of claim 15, further comprising a locking mechanism that is moveable between a locked position, in which it prevents rotation of said adjustment shaft, and an unlocked position, in which said adjustment shaft may be rotated.

18. The spring adjuster of claim 17, wherein said locking mechanism comprises a locking collar that is moveable between said locked and unlocked positions, and a spring that biases said locking collar to said locked position.

19. The spring adjuster of claim 18, wherein said outer surface of said housing comprises a recess surrounding said second opening, wherein said spring is positioned within said recess and said locking collar is positioned between said spring and said second end of said adjustment shaft, and wherein said locking collar surrounds said second end of said adjustment shaft when in its locked position.
